(19) United States
(12) Patent Application Publication
(10) Pub. No.: US 2024/0146486 A1
(43) Pub. Date: May 2, 2024

(54) PROCESSING GAP REQUESTING AND/OR ERROR REPORTING

(71) Applicant: QUALCOMM INCORPORATED, San Diego, CA (US)

(72) Inventors: Alexandros MANOLAKOS, Escondido, CA (US); Mukesh KUMAR, Hyderabad (IN); Srinivas YERRAMALLI, San Diego, CA (US)

(21) Appl. No.: 18/547,643

(22) PCT Filed: Feb. 25, 2022
(86) PCT No.: PCT/US2022/017806

§ 371 Date: Aug. 23, 2023

(30) Foreign Application Priority Data
Apr. 15, 2021 (GR) 20210100261

(51) Int. Cl. H04L 5/00; H04W 72/56

(52) U.S. Cl. CPC H04L 5/0069; H04L 5/0078; H04L 5/0091; H04W 72/56

(57) ABSTRACT

A positioning method includes: transmitting, from a UE to a network entity, a first PG message including a first PG request for a first PG configuration; and transmitting a second PG message from the UE to the network entity in response to lack of an acceptable response to the first PG message being received by the UE, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

### CROSS-REFERENCE TO RELATED APPLICATIONS

This application claims the benefit of Greek Patent Application No. 20210100261, filed Apr. 15, 2021, entitled “PROCESSING GAP REQUESTING AND/OR ERROR REPORTING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

In an embodiment, a UE (user equipment) includes: a transceiver; a memory; and a processor, communicatively coupled to the transceiver and the memory, configured to: transmit, via the transceiver to a network entity, a first PG message (processing gap message) including a first PG request for a first PG configuration; and transmit a second PG message via the transceiver to the network entity in response to lack of an acceptable response to the first PG message being received, the second PG message including a second PG request, or a PG error message, or a combination thereof, where the second PG request indicates a second PG configuration that is different from the first PG configuration, or an acceptance/rejection indication for a proposed PG configuration received by the UE, or a combination thereof, and the PG error message indicates that no PG configuration message was received by the UE or that the proposed PG configuration was deficient.

Implementations of such a UE may include one or more of the following features. The first PG request includes a plurality of first PG configurations, or the second PG message includes the second PG request which includes a plurality of second PG configurations that are different from the first PG request, or a combination thereof. The first PG request includes the plurality of first PG configurations and indicates a first priority of the plurality of first PG configurations, or the second PG message includes the second PG request which includes the plurality of second PG configurations that are different from the first PG request, and the second PG request indicates a second priority of the plurality of second PG configurations, or a combination thereof.

Also or alternatively, implementations of such a UE may include one or more of the following features. The second PG message includes the PG error message and the PG error message indicates whether a proposed PG timing parameter is unacceptable, or whether a proposed PG frequency parameter is unacceptable, or a combination thereof. The PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

Also or alternatively, implementations of such a UE may include one or more of the following features. The processor is configured to transmit the second PG message including the second PG request including the acceptance/rejection indication in response to the processor receiving the proposed PG configuration, the acceptance/rejection indication indicating whether the UE accepts the proposed PG configuration or rejects the proposed PG configuration. The processor is configured to transmit the second PG message including the second PG request including the acceptance/rejection indication in response to the processor receiving a plurality of proposed PG configurations, the acceptance/rejection indication indicating a selected one of the plurality of proposed PG configurations that the UE accepts. The processor is configured to transmit the second PG message including the second PG request in response to passage of a threshold amount of time since transmission of the first PG message without receipt of a PG configuration proposal. The processor is configured to transmit the second PG message including the second PG request in response to passage of a threshold amount of time since transmission of the first PG message without receipt of a PG configuration proposal that is acceptable to the UE. The first PG configuration includes a plurality of first PG configuration parameters, and the processor is configured to determine whether the proposed PG configuration is acceptable to the UE based on whether the plurality of first PG configuration parameters meet at least one combination criterion.

In another embodiment, a positioning method includes: transmitting, from a UE to a network entity, a first PG message including a first PG request for a first PG configuration; and transmitting a second PG message from the UE to the network entity in response to lack of an acceptable response to the first PG message being received by the UE, the second PG message including a second PG request, or a PG error message, or a combination thereof, where the second PG request indicates a second PG configuration that is different from the first PG configuration, or an acceptance/rejection indication for a proposed PG configuration received by the UE, or a combination thereof, and the PG error message indicates that no PG configuration message was received by the UE or that the proposed PG configuration was deficient.

Implementations of such a method may include one or more of the following features. The first PG request includes a plurality of first PG configurations, or the second PG message includes the second PG request which includes a plurality of second PG configurations that are different from the first PG request, or a combination thereof. The first PG request includes the plurality of first PG configurations and indicates a first priority of the plurality of first PG configurations, or the second PG message includes the second PG request which includes the plurality of second PG configurations that are different from the first PG request, and the second PG request indicates a second priority of the plurality of second PG configurations, or a combination thereof.

Also or alternatively, implementations of such a method may include one or more of the following features. The second PG message includes the PG error message and the PG error message indicates whether a proposed PG timing parameter is unacceptable, or whether a proposed PG frequency parameter is unacceptable, or a combination thereof. The PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

Also or alternatively, implementations of such a method may include one or more of the following features. The method includes receiving the proposed PG configuration, and transmitting the second PG message includes transmitting the second PG message including the second PG request including the acceptance/rejection indication in response to receiving the proposed PG configuration, the acceptance/rejection indication indicating whether the UE accepts the proposed PG configuration or rejects the proposed PG configuration. The method includes receiving a plurality of proposed PG configurations, and transmitting the second PG message includes transmitting the second PG message including the second PG request including the acceptance/rejection indication in response to receiving the plurality of proposed PG configurations, the acceptance/rejection indication indicating a selected one of the plurality of proposed PG configurations that the UE accepts. Transmitting the second PG message includes transmitting the second PG message including the second PG request in response to passage of a threshold amount of time since transmission of the first PG message without receipt of a PG configuration proposal. Transmitting the second PG message includes transmitting the second PG message including the second PG request in response to passage of a threshold amount of time since transmission of the first PG message without receipt of a PG configuration proposal that is acceptable to the UE. The first PG configuration includes a plurality of first PG configuration parameters, and the method includes determining whether the proposed PG configuration is acceptable to the UE based on whether the plurality of first PG configuration parameters meet at least one combination criterion.

In another embodiment, a network entity includes: a transceiver; a memory; and a processor, communicatively coupled to the transceiver and the memory, configured to: receive, from a UE, a UE message indicative of one or more first PG parameters indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and provide, based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

Implementations of such a network entity may include one or more of the following features. The processor is configured to provide, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof. The processor is configured to provide, via the transceiver to the UE, the second indication of the one or more second PG parameters indicating a plurality of processing gap configurations. The processor is configured to: receive a selection message, from the UE via the transceiver, indicating a selected one of the plurality of processing gap configurations; and transmit a processing gap configuration message, to a transmission/reception point, indicating the selected one of the plurality of processing gap configurations.

In another embodiment, a positioning method includes: receiving, at a network entity from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and providing, from the network entity to the UE based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

Implementations of such a method may include one or more of the following features. The method includes providing, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof. The method includes providing the second indication of the one or more second PG parameters indicating a plurality of processing gap configurations. The method includes: receiving a selection message, from the UE, indicating a selected one of the plurality of processing gap configurations; and transmitting a processing gap configuration message, to a transmission/reception point, indicating the selected one of the plurality of processing gap configurations.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a simplified flowchart of a method of attempting to obtain a processing gap configuration.

FIG. 7 is a signaling and process flow for obtaining and processing PRS.

FIG. 8 is an example of a processing gap configuration request with one requested processing gap configuration.

FIG. 9 is an example of a processing gap configuration request with multiple requested processing gap configurations.

FIG. 10 is an example of a processing gap configuration response with one proposed processing gap configuration.

FIG. 11 is an example of a processing gap configuration response with multiple proposed processing gap configurations.

FIG. 12 is an example of a processing gap configuration error message.

FIG. 13 is a block flow diagram of a positioning method.

FIG. 14 is a block flow diagram of another positioning method.

### DETAILED DESCRIPTION

Techniques are discussed herein for requesting processing gaps for processing PRS (positioning reference signal(s)) and/or for reporting processing gap deficiencies. For example, a UE (user equipment) can send a request indicating one or more parameters of a desired processing gap (e.g., component carrier(s), frequency layer(s), frequency range(s), etc.). If the UE does not receive a schedule with an acceptable processing gap in response to the request (e.g., no processing gap, or a processing gap with one or more deficient parameters or deficient combination of parameters), then the UE may send another request. The UE may provide multiple processing gap configurations in a request, and may provide a priority of the configurations, e.g., based on component carrier, frequency layer, and/or frequency range, etc. A server may respond to a processing gap request from the UE with multiple processing gap configuration options and the UE may respond by indicating a selection of one of the options. The UE may provide an error message, e.g., to a server, indicating one or more details of a deficient processing gap (e.g., insufficient processing gap length, incorrect processing gap periodicity, incorrect offset, incorrect frequency-domain allocation (e.g., incorrect frequency range, incorrect frequency band, incorrect component carrier), etc.). The server may respond to the error message by changing a positioning reference signal configuration and/or proposing a processing gap configuration based on the error message (e.g., to correct one or more indicated deficiencies). These are examples, and other examples may be implemented.

Items and/or techniques described herein may provide one or more of the following capabilities, as well as other capabilities not mentioned. Positioning accuracy and/or latency may be improved, e.g., by obtaining desired processing gaps to expedite and/or help improve accuracy of PRS measurements. Energy may be reduced for measuring PRS resources, reporting PRS resource measurements, and/or processing PRS resource measurements, e.g., by avoiding measurement attempts without a sufficient processing gap. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

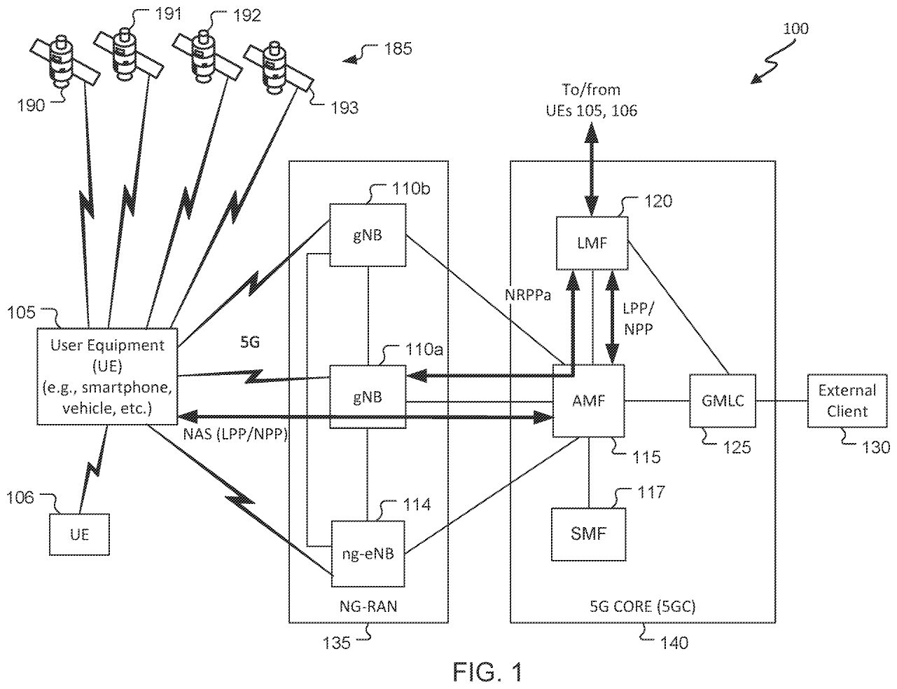

Referring to FIG. 1, an example of a communication system 100 includes a UE 105, a UE 106, a Radio Access Network (RAN) 135, here a Fifth Generation (5G) Next Generation (NG) RAN (NG-RAN), and a 5G Core Network (5GC) 140. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS (Synchronization Signal) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

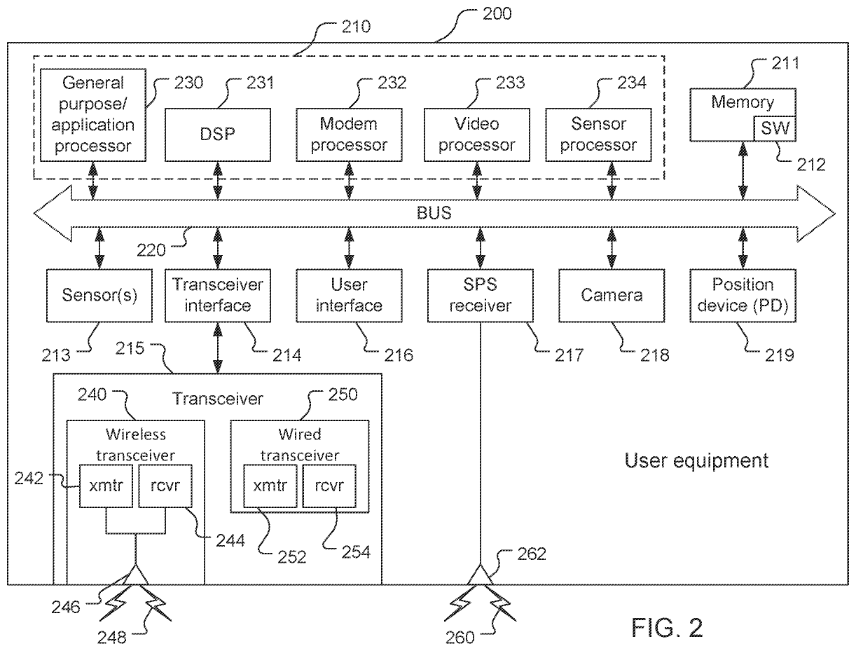

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

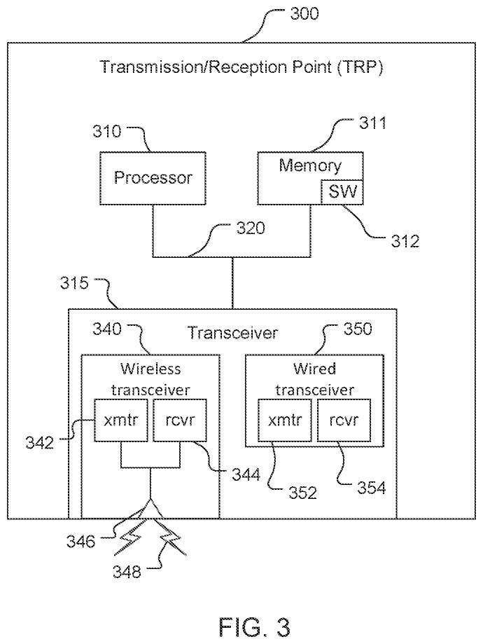

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

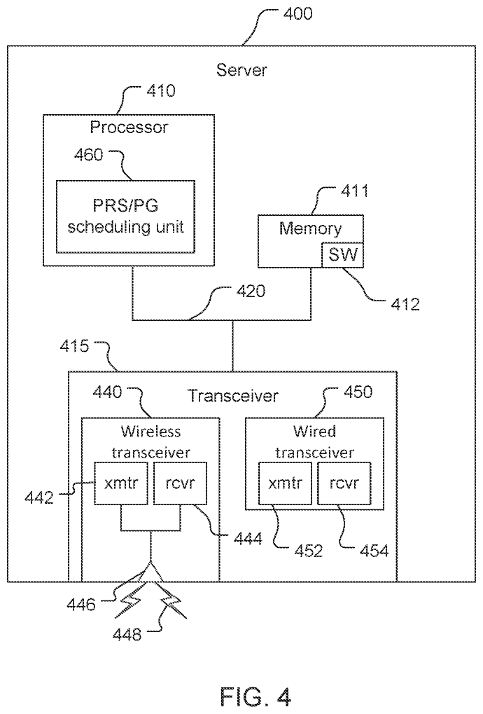

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every NO resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

Processing Gap Requesting and Error Reporting

Processing gaps are used to facilitate measuring signals such as RRM (Radio Resource Management) signals and/or PRS, e.g., by having a period of time free of signals that collide with the RRM and/or PRS. A server (e.g., an LMF) may schedule processing gaps, and the processing gaps may or may not be compatible with a particular UE for measurement of PRS by that UE. As discussed herein, a UE may be configured to request one or more values of one or more processing gap parameters, e.g., based on one or more UE capabilities, to help the UE measure PRS. Also or alternatively, the UE may be configured to indicate one or more specific deficiencies of a processing gap to help a server reconfigure a PRS schedule and/or reconfigure a processing gap. A processing gap (PG) comprises a time window, perhaps for a specific frequency or frequency range, during which the UE can perform PRS processing (e.g., PRS measuring and possibly one or more other processes such as RF retuning to enable or facilitate PRS measurement or measurement of another signal (e.g., after measuring PRS)). Thus, a processing gap may be defined by a PG configuration that includes one or more PG timing parameters and possibly one or more PG frequency parameters. A measurement gap is an example of a processing gap during which the UE may retune RF circuitry for measuring PRS, measure the PRS, and retune the RF circuitry to measure one or more other signals. If the UE can measure a signal (e.g., a PRS) during the processing gap without retuning the RF circuitry before and/or after measuring the signal, then the processing gap may be shorter than if the UE will perform RF retuning before and/or after measuring the signal. The PG may provide a time during which the UE can perform a specific processing task, e.g., PRS processing (e.g., measuring), without receiving one or more requests for other tasks to be performed by the UE. The PG may provide a time during which the UE may ignore other tasks and/or requests for other processing, and/or may provide a time during which the UE may prioritize processing of one or more primary tasks, and may process one or more supplemental tasks if there are available processing resources during the PG beyond the resources for processing the primary task(s).

PRS measurements may be used to help with position determination of mobile devices such as UEs (e.g., a UE 500 discussed further below). For example, various PRS measurements may be used to support UE-assisted and/or UE-based position calculation using one or more of a variety of positioning techniques. For example, DL-PRS may be measured by a PRS measurement unit of a UE (e.g., the PRS measurement unit 560 of the UE 500 discussed below) to determine RSTD for DL-TDOA or to determined RSRP for DL-TDOA, DL-AoD, and/or multi-RTT techniques. As another example, DL-PRS and UL-PRS may be measured by the PRS measurement unit to determine a UE Rx-Tx time difference for multi-RTT. As another example, SSB or CSI-RS (Channel State Information Reference Signal) for RRM may be measured by the PRS measurement unit to determine SS-RSRP (Synchronization Signal RSRP for RRM), SS-RSRQ (for RRM), CSI-RSRP (for RRM), CSI-RSRQ (for RRM) for E-CID.

A UE may use a processing gap (PG) to perform various signal processing such as signal measurements. For example, a PG may be used to make RRM and PRS measurements. RRM measurements may be prioritized over PRS measurements by default, but the UE may be configured to prioritize PRS measurements over RRM measurements. If the UE decides to perform PRS measurements, a previously-configured RRM PG may not be useful, and the UE may de-configure the existing PG and reconfigure a new PG using the RRC (Radio Resource Control) protocol.

Processing gaps may be used in carrier aggregation. In carrier aggregation, multiple receive chains are active at the UE level, and the UE synchronously receives downlink data from multiple component carriers (CCs). It is possible to configure one or more processing gaps on a subset of one or more component carriers. Various gap patterns may be used, with the same gap pattern used on different component carriers, and a gap pattern being unique (i.e., a single gap pattern being used at any one time) or multiple gap patterns being used simultaneously. Selection of the CC(s) for processing gap scheduling may be done at the beginning of a positioning session and remain the same throughout the duration of the positioning session.

Processing gaps may be defined by PG configuration parameters (e.g., for NR). For example, a processing gap offset (PGO) (e.g., a measurement gap offset (MGO)) is a time, after a reference time (e.g., beginning of a slot), at which a processing gap pattern (a sequence of processing gaps defined by gap lengths and time between beginnings of consecutive gaps) begins (i.e., when the first gap in the gap pattern begins). Numerous offset values (presently about 160 different values) may be used, and which offset values are available may vary depending on the periodicity of the PG pattern. The value of the PGO points to the starting subframe within the period, with the value being between 0 and PGRP-1 where PGRP is a processing gap repetition period (e.g., an MGRP (measurement gap repetition period)). For example, for a periodicity of 20 ms, the PGO may be a value between 0 and 19. A processing gap length (PGL) (e.g., a measurement gap length (MGL)) is a time duration in milliseconds of a PG. Various processing gap lengths may be used, e.g., 1.5 ms, 3 ms, 3.5 ms, 4 ms, 5.5 ms, 6 ms, 10 ms, 18 ms, 20 ms, 34 ms, 40 ms, or 50 ms. The PGRP defines the periodicity (in ms) at which the processing gap repeats. Example values of PGRP include 20 ms, 40 ms, 80 ms, 160 ms, 320 ms, and 640 ms. A measurement gap timing advance (MGTA) is an amount of time at the beginning and/or end of a measurement gap during which the UE is switching (e.g., RF retuning) and not measuring. Example values of MGTA include 0.25 ms (for FR2 (Frequency Range 2), e.g., 24.25-52.6 GHz) and 0.5 ms (for FR1, e.g., 410-7125 MHz).

Suitable processing gaps may or may not be configured by the TRP 300. For example, the TRP 300 may not be able to configure a suitable PG (e.g., a PG that will enable the UE to measure PRS with a desired level of accuracy). The TRP 300 may not schedule a processing gap at all, or may configure a processing gap that is not suitable, e.g., that will result in PRS resources arriving outside of the PG. The UE may measure only the PRS resources that arrive inside the PG. If no PG is configured by the TRP 300, then the UE may abort a positioning session and provide an error message to the server 400 (e.g., a location server). For example, according to 3GPP Release 16, an NR-DL-TDOA-Error information element (IE) may be sent by a location server or a target device (device whose location is to be determined) to provide error reasons to the target device or the location server, respectively. An NR-DL-TDOA-TargetDeviceErrorCauses IE of the NR-DL-TDOA-Error IE may indicate that assistance data are missing, that the target UE is unable to measure any TRP, that the target UE attempted to but was unable to measure neighbor TRPs, that not enough signals were received by the target UE for UE-based DL-TDOA, and/or that location calculation assistance data are missing. Lack of a suitable processing gap may have various consequences. For example, if a UE is configured with multiple CCs before a positioning session starts and the UE requests a PG on the primary CC but the TRP 300 does not configure (e.g., is unable to configure) the requested PG configuration, then the UE may not be able to perform any measurements and may abort the positioning session.

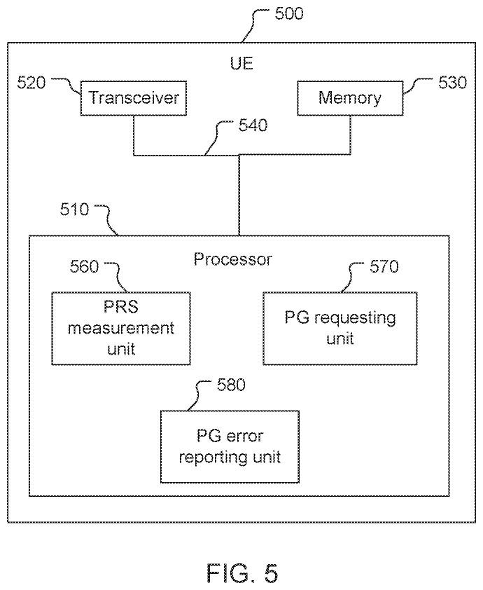

Referring also to FIG. 5, a UE 500 includes a processor 510, a transceiver 520, and a memory 530 communicatively coupled to each other by a bus 540. The UE 500 may include the components shown in FIG. 5, and may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a PRS measurement unit 560, a PG requesting unit 570, and a PG error reporting unit 580. The PRS measurement unit 560, the PG requesting unit 570, and the PG error reporting unit 580 are discussed further below, and the description may refer to the processor 510 generally, or the UE 500 generally, as performing any of the functions of the PRS measurement unit 560, the PG requesting unit 570, and/or the PG error reporting unit 580, with the UE 500 being configured to perform the functions of the PRS measurement unit 560, the PG requesting unit 570, and/or the PG error reporting unit 580.

The PG requesting unit 570 may be configured to request one or more PG configurations based on the measurement capability(ies) of the PRS measurement unit 560. The PRS measurement unit 560 may be configured (e.g., designed and made) to measure PRS received during processing gaps with one or more acceptable PG configurations each having one or more specific PG configuration parameter values. Based on the measurement capability(ies) of the PRS measurement unit 560, the PG requesting unit 570 may specify one or more PG configuration parameter values for one or more PG configurations, respectively, that would be acceptable to the UE 500 (e.g., in view of which the PRS measurement unit 560 is expected to measure PRS resources with at least a threshold acceptable quality, e.g., at least a threshold acceptable accuracy). The PG requesting unit 570 may specify a respective range of values for each of one or more specified PG configuration parameters. The PG requesting unit 570 may be configured to request one or more PG configurations specific to one or more component carriers, one or more frequency bands, one or more frequency ranges, one or more positioning frequency layers (PFLs), or any combination thereof (e.g., a PFL and a CC). Multiple requested PG configurations may be directed to multiple (even all) PG configuration parameter values (e.g., all PFLs, all FRs, etc.).

The PG requesting unit 570 may indicate a priority preference of specified PG configurations (e.g., priority of parameters and/or parameter values). The priority may be explicit or implicit (e.g., an order of the specified parameters in the request being a priority order). The PG requesting unit 570 may, for example, specify that a requested PG configuration (of one or more specified PG configuration parameters with respective PG configuration parameter value(s)) has higher priority than another requested PG configuration. The PG requesting unit 570 may be configured to determine the priority preference based on reference signal measurements, e.g., based on RSRPs of one or more reference signals for respective frequency parameters (e.g., CC, PFL, frequency band, frequency range). For example, frequency parameters with better corresponding RSRPs may be given higher priority than frequency parameters with worse corresponding RSRPs.

The priority preference may provide a priority order of more than two requested PG configurations. The priority preference may, for example, specify which CC of multiple CCs has which priority (e.g., highest priority). As another example, the priority preference may indicate that a specified CC has a higher priority than a specified FR such that a PG configuration with the specified CC is preferred over a PG configuration with the specified FR. The PG requesting unit 570 may be configured to have the priority preference indicate a priority of any PG configuration parameter (e.g., CC, PFL, frequency band, FR) or combination thereof relative to any other PG configuration parameter (e.g., CC, PFL, frequency band, FR) or combination thereof, and/or relative to any other PG configuration parameter value (e.g., one CC relative to another CC, or one CC relative to two PFLs (e.g., with higher priority than one PFL but lower priority than another PFL), etc.). The priority preference indicates that if multiple PG configurations are possible (e.g., may be provided by the TRP 300), then the higher(est)-priority PG configuration is preferred to be scheduled. Thus, the server 400 may instruct the TRP 300 to schedule the higher(est)-priority PG configuration.

The PG requesting unit 570 may be configured to request one or more initial PG configurations and, in response to lack of receipt of an acceptable PG configuration being scheduled, request one or more subsequent PG configurations. The PG requesting unit 570 may request the one or more subsequent PG configurations such that the one or more subsequent PG configurations are different from the one or more initial PG configurations (e.g., each of the initial PG configuration(s) and the subsequent PG configuration(s) being unique within the set of the initial PG configuration(s) and the subsequent PG configuration(s)). The PG requesting unit 570 may be configured to re-request one or more of the initial PG configuration(s) in response to lack of an acceptable PG configuration being scheduled based on the request for the subsequent PG configuration(s).

The PG error reporting unit 580 may be configured to indicate an unacceptable scheduled or proposed PG configuration based on the capability(ies) of the PRS measurement unit 560. For example, based on the one or more acceptable PG configurations for the PRS measurement unit 560, the PG error reporting unit 580 may be configured to report one or more specific deficiencies of a (proposed or scheduled) processing gap. The PG error reporting unit 580 may be configured to indicate that a PG configuration parameter value is not an acceptable value (e.g., not in an acceptable range, or deviates by more than a threshold amount from an acceptable value). For example, the PG error reporting unit 580 may be configured to provide a processing-gap-too-short indication in response to a scheduled PGL being shorter than an acceptable length, e.g., more than a threshold amount different (less) than a specified acceptable value, or not being a value, or being outside a range of values that the PRS measurement unit 560 expects or is configured to use. The threshold may be an absolute value (e.g., an amount of time) or a relative value (e.g., a percentage or ratio). As another example, the PG error reporting unit 580 may be configured to provide a wrong-periodicity indication in response to a proposed periodicity not being acceptable, e.g., not being the value (or within a range of values) specified in a request, or not being a value or being outside a range of values that the PRS measurement unit 560 expects or is configured to use. As another example, the PG error reporting unit 580 may be configured to provide a wrong offset indication in response to a proposed offset not being acceptable. As another example, the PG error reporting unit 580 may be configured to provide an indication that no PG was configured, e.g., in response to a threshold amount of time passing, after a request for a PG configuration is sent, without any PG configuration being received by the UE 500. As another example, the PG error reporting unit 580 may be configured to provide a wrong-frequency-domain-allocation indication, e.g., indicating a wrong frequency range in response to a proposed frequency range being unacceptable (or missing), and/or indicating a wrong band ID in response to an indicated frequency band ID being unacceptable (or missing), and/or indicating a wrong CC ID in response to an indicated CC ID being unacceptable (or missing).

The PG error reporting unit 580 may be configured to indicate unacceptable values of multiple PG configuration parameter values. The PG error reporting unit 580 may be configured to indicate an unacceptable combination of PG configuration parameter values (e.g., where each individual PG configuration parameter value is acceptable but a combination of the values is unacceptable such as an acceptable PGL value and an acceptable PGRP value, but the PGL value and the PGRP value in combination yield an unacceptable result, e.g., an insufficient number of slots or REs to obtain an acceptably accurate PRS measurement).

The server 400 may be configured to respond to a request for one or more PG configurations and/or to an error message from the UE 500. The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function. The processor 410 (possibly in conjunction with the memory 411 and, as appropriate, the transceiver 415) may include a PRS/PG scheduling unit 460. The PRS/PG scheduling unit 460 is discussed further below, and the description may refer to the processor 410 generally, or the server 400 generally, as performing any of the functions of the PRS/PG scheduling unit 460, with the server 400 being configured to perform the functions.

The PRS/PG scheduling unit 460 may be configured to respond to a request for one or more PG configurations, e.g., by sending a PG configuration and/or one or more proposed PG configurations. For example, the PRS/PG scheduling unit 460 may send a PG configuration with PG configuration parameter values that satisfy each specified parameter value(s) of the request (e.g., matches a specified value or is in a specified range of values). As another example, the PRS/PG scheduling unit 460 may send a PG configuration that does not meet a requested PG configuration, but with the PRS/PG scheduling unit 460 sending a PG configuration with PG configuration parameter values as close to the requested values as possible (e.g., providable by the server 400 or other network entity (e.g., the TRP 300)). As another example, the PRS/PG scheduling unit 460 may send multiple proposed PG configurations to the UE 500, wait for a reply from the UE 500 selecting one of the proposed PG configurations, and respond to receiving a response selecting one of the PG configurations by configuring the selected PG configuration (e.g., sending a schedule of the selected PG configuration to the UE 500 and a TRP 300, or sending an acknowledgement of the selection such that the TRP 300 will implement the selection and the UE 500 can expect the selected PG configuration to be implemented by the TRP 300).

The PG requesting unit 570 may be configured to respond to receiving one or more proposed PG configurations. For example, in response to receiving one proposed PG configuration, the PG requesting unit 570 may determine whether the proposed PG configuration is acceptable. The PG requesting unit 570 may respond to the proposed PG configuration being acceptable by sending an acceptance of the proposed PG configuration. The PG requesting unit 570 may respond to the proposed PG configuration being unacceptable by sending a rejection of the proposed PG configuration, and may or may not send a request indicating one or more acceptable PG configurations. As another example, in response to receiving multiple proposed PG configurations, the PG requesting unit 570 may determine whether one or more of the proposed PG configurations is(are) acceptable. For example, the PG requesting unit 570 may send an acceptance of the first of the proposed PG configurations that the PG requesting unit 570 determines to be acceptable. As another example, the PG requesting unit 570 may determine that multiple PG configurations of the proposed PG configurations are acceptable, and send an indication of a selected one (e.g., a highest-priority PG configuration) of the acceptable PG configurations. As another example, the PG requesting unit 570 may determine that multiple PG configurations of the proposed PG configurations are acceptable, and send an indication of multiple acceptable ones of the proposed PG configurations, and a priority of the indicated PG configurations. The PRS/PG scheduling unit 460 may reply to a prioritized indication of multiple ones of the proposed PG configurations by implementing one of the PG configurations (e.g., according to a priority of PG configurations desired by the server 400).

The PRS/PG scheduling unit 460 may be configured to respond to an error message from the UE 500, e.g., by changing a PRS configuration and/or a PG configuration. For example, the PRS/PG scheduling unit 460 may respond to an error message from the UE 500, indicating that a PG configuration is unacceptable, by changing a PRS configuration. The PRS/PG scheduling unit 460 may change one or more timing parameters and/or one or more frequency parameters of a PRS schedule, and may select the new parameter value(s) based on the error message content, e.g., to change the FR of the PRS in response to the error message including a wrong-FR indication. As another example, the PRS/PG scheduling unit 460 may respond to an error message from the UE 500 by changing a PG configuration. The PRS/PG scheduling unit 460 may, for example, propose one or more different PG configuration parameter values to the TRP 300, and select the new parameter value(s) based on the error message content, e.g., to change the FR of the PG configuration in response to the error message including a wrong-FR indication, and/or to extend the PGL in response to a measurement-gap-too-short indication, etc. The PRS/PG scheduling unit 460 may also or alternatively change one or more other PG configuration parameter values as appropriate (e.g., to change an offset, a periodicity, a frequency band, and/or one or more CCs, etc.). The PRS/PG scheduling unit 460 may determine one or more PG configuration parameter values based on one or more requests from the UE 500 in addition to the error message, e.g., to change the PGL to at least a requested length and not just longer than a previous (proposed) configuration.

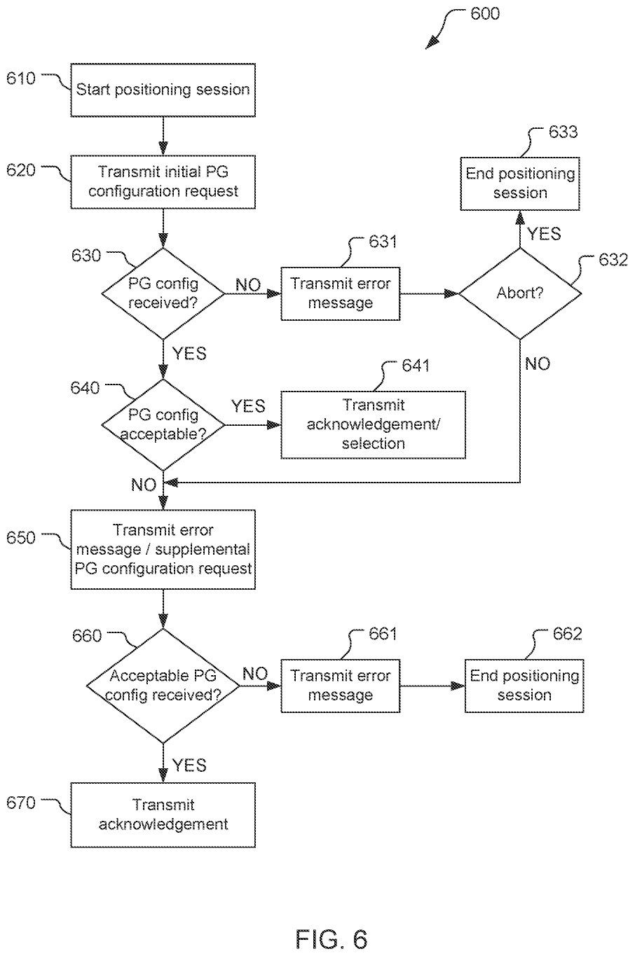

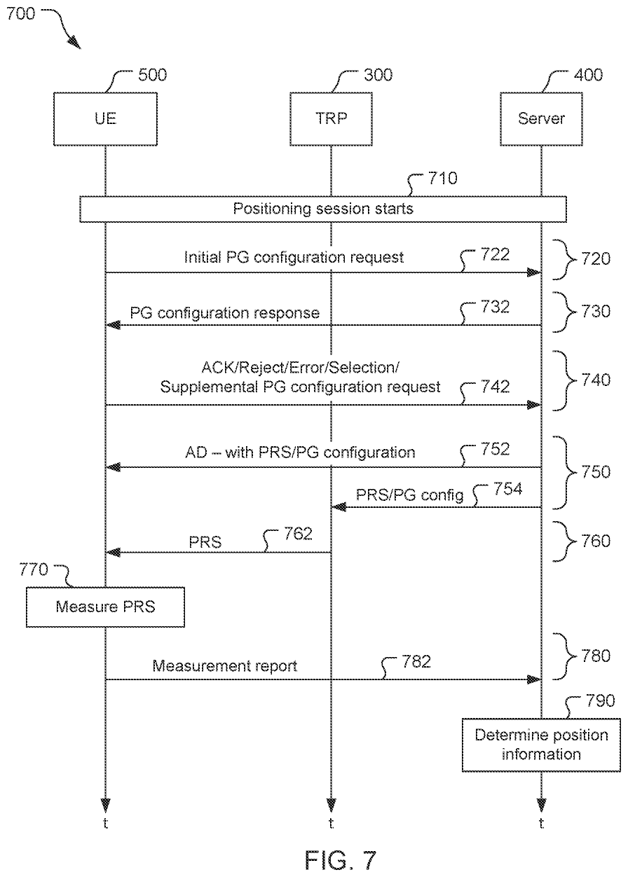

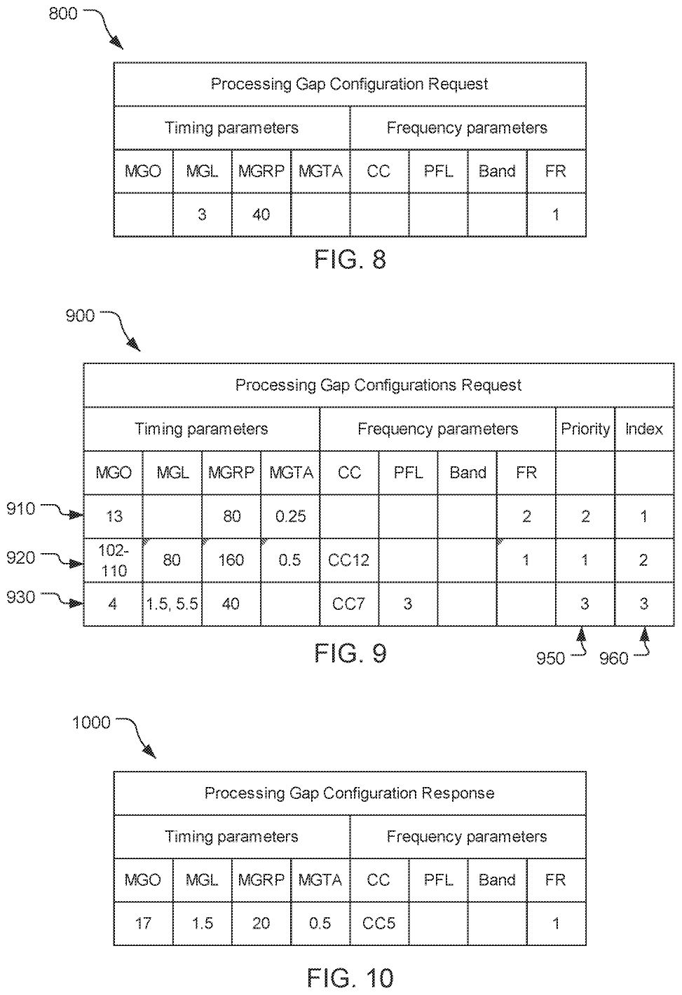

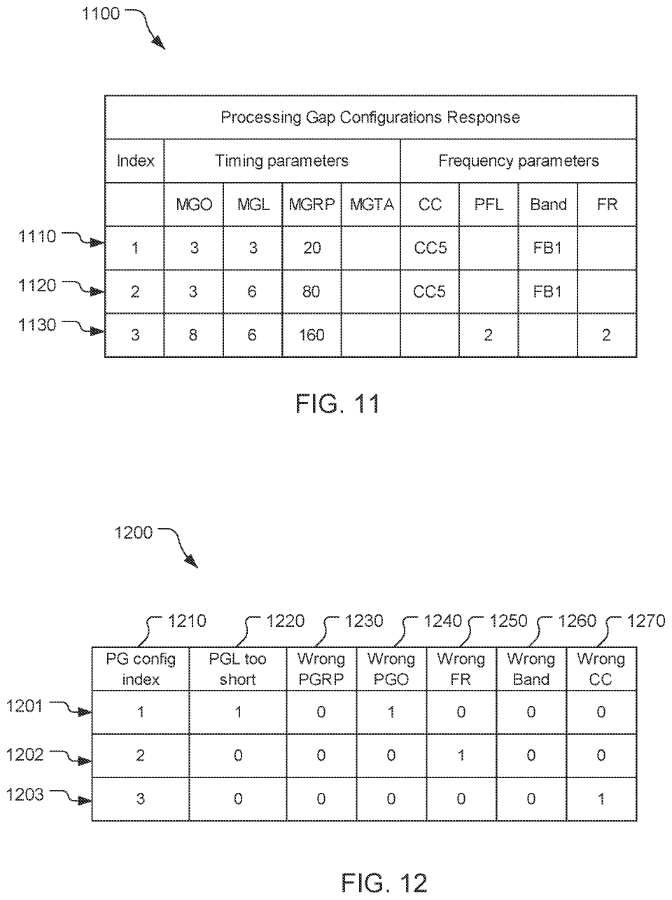

Referring also to FIGS. 6 and 7, with further reference to FIGS. 8-12, a method 600 of attempting to obtain a processing gap configuration and a signaling and process flow 700 for obtaining and processing PRS include the respective stages shown. The method 600 and the flow 700 are, however, examples and not limiting. The method 600 and/or the flow 700 may be altered, e.g., by having stages added, removed, rearranged, combined, performed concurrently, and/or having single stages split into multiple stages.

At stages 610 and 710, a positioning session is started. For example, the UE 500 and the server 400 perform a handshaking procedure via the TRP 300 to establish a communication session for exchanging signaling for use in determining a position (location) of the UE 500.

At stages 620, 720 the UE 500 transmits an initial PG configuration request 722 to the server 400. For example, the PG requesting unit 570 may transmit a PG configuration request 800 indicating one or more requested parameter values of one or more PG configuration parameters. A PG configuration request may include one or more timing parameter values and/or one or more frequency parameter values of a PG configuration that is acceptable to the UE 500 (that the UE 500 is configured to use to measure a PRS, e.g., with acceptable accuracy). In the example of FIG. 8, the PG configuration request 800 is an MG configuration request including values for MGL, MGRP, and FR, here 3 ms, 40 ms, and FR1, respectively. A PG configuration request that is not an MG configuration request may not include an MGTA field and may not include one or more of the frequency parameter fields shown in FIG. 8. In this example, a single MG configuration is included in the PG configuration request 800, but a request may include multiple PG configurations. For example, a PG configuration request 900, which is an MG configuration request, includes three different MG configurations, each of which is acceptable to the UE 500. A PG configuration request with multiple PG configurations may explicitly or implicitly indicate a priority of one or more (possibly all) of the PG configurations indicated. For example, PG configurations 910, 920, 930 (in this example, MG configurations) may be listed in an order of priority, e.g., a descending order of priority (a descending order of which MG configuration the UE 500 prefers). Also or alternatively, the PG configuration request 900 may include a priority field 950 indicating a priority index for each corresponding PG configuration 910, 920, 930. Fewer than all of the PG configurations in a PG configuration request may be assigned a priority. Each of the PG configurations 910, 920, 930 may be assigned an index number 960, e.g., to facilitate reference to a particular PG configuration. One or more parameters in a PG configuration may have multiple acceptable values indicated, e.g., multiple individual values or a range of values (e.g., values of 1.5 ms and 5.5 ms for the MGL of the PG configuration 930, or the range of values 102-110 ms for the MGO of the PG configuration 920). Requesting one or more acceptable PG configurations (or selecting an acceptable proposed PG configuration) may help reduce latency by obtaining an acceptable PG configuration quickly, which may help expedite successful PRS measurement (measurement with at least a desired quality) and reporting. Requesting/selecting an acceptable PG configuration may reduce energy used to measure PRS and may help improve accuracy of PRS measurements.

At stage 730, the server 400 transmits a PG configuration response 732 to the UE 500. The PRS/PG scheduling unit 460 may determine a PG configuration based on the PG configuration request 722, e.g., to try to configure a PG meeting all the requested values of a requested PG configuration (e.g., all the values in the PG configuration request 800, or all of the values in any one of the PG configurations 910, 920, 930). For example, the PG configuration response 732 could be an indication of confirmation of a PG configuration requested in the PG configuration request 722. For example, the PG configuration response 732 could be an indication of an acceptance of the requested PG configuration in the PG configuration request 800, or an indication of an accepted one of the PG configurations 910, 920, 930, e.g., an indication of the index number 960 of the selected (accepted) PG configuration of the PG configurations 910, 920, 930. As another example, the PG configuration response 732 may contain information similar to the PG configuration request 722, e.g., including one or more values of one or more timing parameters and/or one or more values of one or more frequency parameters. For example, a PG configuration response 1000 includes values of MGO, MGL, MGRP, MGTA, CC, and FR because the PG configuration response 1000 is an MG configuration response (but could include values of PGO, PGL, PGRP, CC, and FR, for example). As another example, a PG configuration response 1100 includes multiple proposed PG configurations 1110, 1120, 1130. The PRS/PG scheduling unit 460 may be unable or unwilling to configure a processing gap in accordance with the requested PG configuration, or any of the requested PG configurations of the request 722 including values for parameters of multiple PG configurations. The PRS/PG scheduling unit 460 may propose one or more PG configurations that is(are) different from any requested PG configuration (i.e., not identical to any requested PG configuration). The PRS/PG scheduling unit 460 may propose the one or more PG configurations in addition to, or instead of, acceptance of a requested PG configuration. The server 400 may thus give the UE 500 the option of using a requested PG configuration or another proposed PG configuration.

At stage 630, the UE 500 determines whether a PG configuration is received. If a PG configuration is received, then the method 600 proceeds to stage 640 and if no PG configuration is received, then the method 600 proceeds to stage 631. The PG configuration response 732 may not reach the UE 500 or may reach the UE 500 but have such poor SNR (signal-to-noise ratio) that the UE 500 cannot determine the contents of the PG configuration response. In either of these cases, the PG configuration is considered not to have been received, and the method 600 proceeds to stage 631. At stage 631, the PG error reporting unit 580 transmits an appropriate error message to the server 400. For example, the PG error reporting unit 580 may transmit, at stage 740, a response message 742 to the server 400, with the contents of the message 742, in this case, indicating that no PG configuration was received. The method 600 proceeds to stage 632 where the UE 500 decides whether to abort the positioning session. If the UE 500 decides to abort, then the method 600 proceeds to stage 633 where the positioning session is ended. Alternatively, if the UE 500 does not want to abort the positioning session, then the method 600 proceeds to stage 650.

At stage 640, the UE 500 determines whether a received PG configuration is acceptable. The UE 500 may analyze the PG configuration response 732 to determine whether the indicated PG configuration, or one of multiple proposed PG configurations, is acceptable. For example, the UE 500 may analyze the proposed PG configuration(s) and determine whether a proposed PG configuration in the PG configuration response matches a requested PG configuration identically (at least the requested values). As another example, the UE 500 may analyze the proposed PG configuration(s) and determine whether the PRS measurement unit 560 may measure PRS using any of the proposed PG configuration(s). A proposed value of a PG configuration parameter may be acceptable if the proposed value is identical to a requested value for that parameter indicated in a PG configuration request, or possibly within a threshold proximity of the requested value (e.g., a threshold quantity or a threshold ratio (e.g., percent)) and such that the proposed value does not render the PG configuration as a whole unacceptable (e.g., producing an unacceptable combination of parameter values). The UE 500 may determine not only whether a proposed PG configuration is acceptable, but also why an unacceptable PG configuration is unacceptable (e.g., what parameter value is unacceptable and why, e.g., value too small, value too high, combination of values is unacceptable (e.g., resulting in too few resource elements for measurement), etc.). The UE 500 may be configured to analyze all proposed PG configurations to determine acceptability, or may be configured to stop analyzing proposed PG configurations in response to an acceptable PG configuration being found among multiple proposed PG configurations. If an acceptable PG configuration is received, then the method proceeds to stage 641. At stage 641, the UE 500 transmits an acknowledgement/selection message to the server 400. For example, the UE 500 may transmit the message 742 indicating acknowledgement that the sole proposed PG configuration is acceptable, or a selection indicating a selected one PG configuration of multiple proposed PG configurations that is acceptable, or a selection indicating multiple PG configurations that are acceptable (and possibly providing an indication of priority of one or more of the indicated PG configurations). The method 600 may end, with a PG configuration having been agreed to between the UE 500 and the server 400. If no acceptable PG configuration is received, then the method 600 proceeds from stage 640 to stage 650.

At stage 650, the UE 500 transmits an error message and/or a supplemental PG configuration request to the server 400. For example, the PG error reporting unit 580 may transmit the message 742 indicating that the UE 500 rejects the sole PG configuration proposed, or indicating that all proposed PG configurations are rejected. The PG error reporting unit 580 may indicate one or more errors with the proposed PG configuration(s). For example, the PG error reporting unit 580 may send an error message 1200 that includes fields for a PG configuration index 1210, PGL too short 1220, wrong PGRP 1230, wrong PGO 1240, wrong FR 1250, wrong frequency band 1260, and wrong CC 1270. In this example, a field value of one for any of the fields 1210, 1220, 1230, 1240, 1250, 1260, 1270 indicates that the corresponding parameter is true (e.g., PGL too short is true), while a value of zero indicates that the parameter is false (e.g., wrong PGRP is false). The message 1200 is an example and more or fewer fields and/or different fields may be included in an error message (e.g., for an MG error message, a wrong MGTA field (indicating that at least one of a start MGTA (for the timing advance at a beginning of an MG) or an end MGTA (for the timing advance at an end of an MG) is wrong), a wrong start MGTA field, and/or a wrong end MGTA field may be provided). The message 1200 is an example of a response to multiple proposed PG configurations and includes sub-messages 1201, 1202, 1203 corresponding to respective proposed PG configurations, and the PG configuration index 1210 indicates the index number of the corresponding proposed PG configuration to which the sub-message 1201-1203 pertains. As another example, in addition to or instead of the PG error reporting unit 580 transmitting the error indication(s), the PG requesting unit 570 may transmit the message 742 with a supplemental PG configuration request indicating one or more PG configurations (e.g., the PG configuration request 800 or the PG configurations request 900), each PG configuration including one or more PG timing parameters and/or one or more PG frequency parameters (i.e., one or more values of one or more such parameters). The supplemental PG configuration request may include one or more PG configurations that is(are) different from the one or more PG configurations included in the initial PG configuration request 722. For example, the PG requesting unit 570 may produce and transmit the supplemental PG configuration request such that every PG configuration in the supplemental PG configuration request is different from (unique with respect to) every PG configuration in the initial PG configuration request 722. Thus, the supplemental PG configuration request may have no supplemental PG configuration that is identical to a PG configuration in the initial PG configuration request (i.e., each PG configuration in the supplemental PG configuration request, when compared to the PG configuration request(s) of the initial PG configuration request, has at least one parameter value that is different relative to each PG configuration in the initial PG configuration request, although which parameter value is different may vary from comparison to comparison). A parameter value may be considered to be different between two configurations if a value is provided in one configuration and not in the other configuration.

At stage 660, the UE 500 determines whether an acceptable PG configuration is received. For example, at stage 750 the server 400 may transmit assistance data (AD) 752 to the UE 500, with the AD 752 including a PRS schedule and a PG configuration. Similar to stages 630 and 640, the UE 500 may determine whether the PG configuration is received, and if so, whether the received PG configuration is acceptable. If no acceptable PG configuration is received, then the method 600 proceeds to stage 661, where the PG error reporting unit 580 transmits an appropriate error message, and then to stage 662 where the positioning session is ended. If an acceptable PG configuration is received, e.g., in the AD 752, then the method 600 proceeds to stage 670 where the UE 500 transmits an acknowledgement of the acceptable PG configuration to the server 400.

The method 600 is an example, and numerous variations are possible. For example, stage 670 may be omitted. As another example, stages 660, 661, 662, 670 could be omitted, and a method could proceed from stage 650 to stage 630. Stage 650 could be modified so that after a specified number of attempts to obtain an acceptable PG configuration, the positioning session would be terminated instead of the method returning to stage 630. Still other variations are possible.

At stage 750, in addition to transmitting the AD 752 to the UE 500, the server 400 transmits a PRS/PG configuration message 754 to the TRP 300. The PG configuration in the PRS/PG configuration message 754 may or may not have been agreed to by the UE 500 and the server 400. Thus, the PG configuration may be a proposed PG configuration that may or may not be acceptable to the UE 500. The AD 752 may include a confirmation of a previous PRS schedule or may reflect a new PRS schedule (possibly a reconfiguration of a previous PRS schedule). Provision (e.g., by the error message 1200) of one or more reasons for unacceptability of a proposed PG configuration may help the server 400 determine an acceptable PRS configuration and/or PG configuration quicker than without such information, which may reduce latency and/or reduce power consumption (e.g., by reducing communication to determine an acceptable PRS configuration and/or PG configuration, and/or by reducing energy spent trying to measure PRS with an unacceptable or non-existent PG configuration).

At stage 760, the TRP 300 transmits PRS 762 to the UE 500. For example, the TRP 300 transmits DL-PRS to the UE 500 in accordance with the PRS schedule indicated in the AD 752 and the PRS/PG configuration message 754.

At stage 770, the UE 500 processes the PRS 762. For example, the PRS measurement unit 560 measures the PRS 762, taking advantage of the PG configuration indicated by the AD 752.

At stage 780, the UE 500 may report measured PRS. For example, the PRS measurement unit 560 may transmit a PRS measurement report 782 to the server 400 (directly or via the TRP 300). The PRS measurement report 782 may comprise one or more messages (e.g., separate messages). The report 782 may include other position information (e.g., pseudoranges, location estimates) in addition to PRS resource measurements.

At stage 790, the server 400 determines position information. For example, the processor 410 may use the measurement report 782 to determine one or more pseudoranges and/or one or more location estimates of the UE 500 (the target UE) using one or more appropriate positioning techniques (e.g., AoD, RTT, multi-RTT, DL-TDOA, etc.).

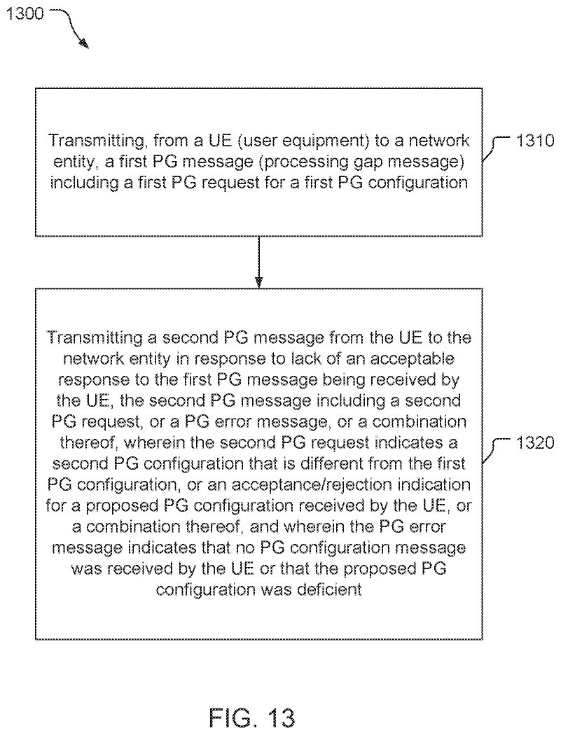

Referring to FIG. 13, with further reference to FIGS. 1-12, a positioning method 1300 (e.g., for assisting measurement of a positioning signal) includes the stages shown. The method 1300 is, however, an example and not limiting. The method 1300 may be altered, e.g., by having stages added, removed, rearranged, combined, performed concurrently, and/or having single stages split into multiple stages.

At stage 1310, the method 1300 includes transmitting, from a UE to a network entity, a first PG message including a first PG request for a first PG configuration. For example, the PG requesting unit 570 transmits the initial PG configuration request 722 including a first PG timing parameter, or a first PG frequency parameter, or a combination thereof (e.g., the request 800 or the request 900) to the server 400. The processor 510, possibly in combination with the memory 530, in combination with the transceiver 520 (e.g., the wireless transmitter 242 and the antenna 246) may comprise means for transmitting the first PG message.

At stage 1320, the method 1300 includes transmitting a second PG message from the UE to the network entity in response to lack of an acceptable response to the first PG message being received by the UE, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient. For example, the PG requesting unit 570 transmits, to the server 400 in the message 742, the supplemental PG configuration request, or an acceptance of one or more proposed PG configurations, or a rejection of one or more proposed PG configurations, or an error message, or any combination of two or more of these. If the supplemental PG configuration request is included, the supplemental PG configuration request may include a second PG timing parameter different from the first PG timing parameter (if included in the first PG request), and/or a second PG frequency parameter different from the first PG frequency parameter (if included in the first PG request). The processor 510, possibly in combination with the memory 530, possibly in combination with the transceiver 520 (e.g., the wireless transmitter 242 and the antenna 246), may comprise means for transmitting the second PG message.

Implementations of the method 1300 may include one or more of the following features. In an example implementation, the first PG request includes a plurality of first PG configurations, or the second PG message includes the second PG request which includes a plurality of second PG configurations that are different from the first PG request, or a combination thereof. For example, the initial PG configuration request 722 and/or the supplemental PG configuration request (e.g., the message 742) may include multiple acceptable PG configurations, e.g., such as the PG configuration request 900. The supplemental PG configurations are different from the initial PG configuration request, e.g., each of the supplemental PG configurations being different from all of the PG configuration(s) of the initial PG configuration request. In a further example implementation, the first PG request includes the plurality of first PG configurations and indicates a first priority of the plurality of first PG configurations; or the second PG message includes the second PG request which includes the plurality of second PG configurations that are different from the first PG request, and the second PG request indicates a second priority of the plurality of second PG configurations; or a combination thereof. For example, the initial PG configuration request 722 and/or the supplemental PG configuration request (e.g., the message 742) may include an implicit or explicit indication of priority of one or more of the requested PG configurations, e.g., as shown in the PG configuration request 900. The priority(ies) indicated in the initial PG configuration request 722 and/or the supplemental PG configuration request may be based, for example, on CCs, PFLs, and/or FRs.

Also or alternatively, implementations of the method 1300 may include one or more of the following features. In an example implementation, the second PG message includes the PG error message and the PG error message indicates whether a proposed PG timing parameter is unacceptable, or whether a proposed PG frequency parameter is unacceptable, or a combination thereof. For example, the message 742 may indicate generally that a timing parameter of a proposed PG configuration is unacceptable and/or generally that a frequency parameter of a proposed PG configuration is unacceptable, i.e., that a value of a proposed timing parameter is unacceptable and/or that a value of a proposed frequency parameter is unacceptable. As another example, the message 742 may indicate which proposed timing parameter and/or which proposed frequency parameter is unacceptable, and may indicate a reason for the unacceptability. In a further example implementation, the PG error message indicates that a proposed processing gap (e.g., measurement gap) is too short, or that a proposed processing gap (e.g., measurement gap) periodicity is incorrect, or that a proposed processing gap (e.g., measurement gap) offset is incorrect, or that a proposed processing gap (e.g., measurement gap) frequency range is incorrect, or that a proposed processing gap (e.g., measurement gap) frequency band is incorrect, or that a proposed processing gap (e.g., measurement gap) component carrier is incorrect, or any combination thereof (e.g., PGL too short and PGO incorrect, etc.).

Also or alternatively, implementations of the method 1300 may include one or more of the following features. In an example implementation, the method 1300 comprises receiving the proposed PG configuration, and transmitting the second PG message comprises transmitting the second PG message including the second PG request including the acceptance/rejection indication in response to receiving the proposed PG configuration, the acceptance/rejection indication indicating whether the UE accepts the proposed PG configuration or rejects the proposed PG configuration. For example, the UE 500 sends the message 742 in response to receiving multiple proposed PG configurations (e.g., the PG configuration response 1100), with the message 742 indicating an acceptance of one or more of the proposed PG configurations, and possibly indicating a rejection of one or more of the proposed PG configurations. If any proposed PG configuration is accepted, other proposed PG configurations may or may not be indicated in the message 742 as being accepted or rejected. The message 742 may indicate an acceptance or rejection for each and every proposed PG configuration. The processor 510, possibly in combination with the memory 530, in combination with the transceiver 520 (e.g., the wireless receiver 244 and the antenna 246) may comprise means for receiving the proposed PG configuration. In another example implementation, the method 1300 comprises receiving a plurality of proposed PG configurations, and transmitting the second PG message comprises transmitting the second PG message including the second PG request including the acceptance/rejection indication in response to receiving the plurality of proposed PG configurations, the acceptance/rejection indication indicating a selected one of the plurality of proposed PG configurations that the UE accepts. For example, the UE 500 may transmit the message 742 at stage 740 (and stage 641) indicating one of multiple proposed PG configurations that is acceptable to the UE 500, i.e., that the UE 500 selects for the server 400 to implement by scheduling the selected PG configuration. In another example implementation, transmitting the second PG message comprises transmitting the second PG message including the second PG request in response to passage of a threshold amount of time since transmission of the first PG message without receipt of a PG configuration proposal. For example, the UE 500 may transmit an error message at stage 631 (e.g., as part of the message 742 at stage 740), if the UE 500 does not receive a proposed PG configuration within a threshold time after transmitting the initial PG configuration request 722.

Also or alternatively, implementations of the method 1300 may include one or more of the following features. In an example implementation, transmitting the second PG message comprises transmitting the second PG message including the second PG request in response to passage of a threshold amount of time since transmission of the first PG message without receipt of a PG configuration proposal that is acceptable to the UE. For example, the UE 500 may transmit the supplemental PG configuration request at stage 650 (e.g., as part of the message 742 at stage 740), if the UE 500 does not receive a proposed PG configuration within a threshold time after transmitting the initial PG configuration request 722, and decides at stage 632 not to abort the positioning session, or if the UE 500 determines at stage 640 that no received proposed PG configuration is acceptable. The UE 500 may determine that the proposed PG configuration is acceptable to the UE based, for example, on every one of the at least one first PG configuration parameter having a first value that is identical to, or within a respective threshold of, a second value of a corresponding second PG configuration parameter in the proposed PG configuration. If no value is provided for a first PG configuration parameter, then any value for that parameter may be acceptable (e.g., if a value in combination with other parameter values does not result in an unacceptable combination). In a further example implementation, the first PG configuration includes a plurality of first PG configuration parameters, and the method 1300 comprises determining whether the proposed PG configuration is acceptable to the UE based on whether the plurality of first PG configuration parameters meet at least one combination criterion. For example, the UE 500 may determine whether a combination of PG configuration parameters is acceptable, e.g., will provide a processing gap sufficient for measuring a PRS with desired accuracy (e.g., will permit measurement of a sufficient number of slots or resource elements).

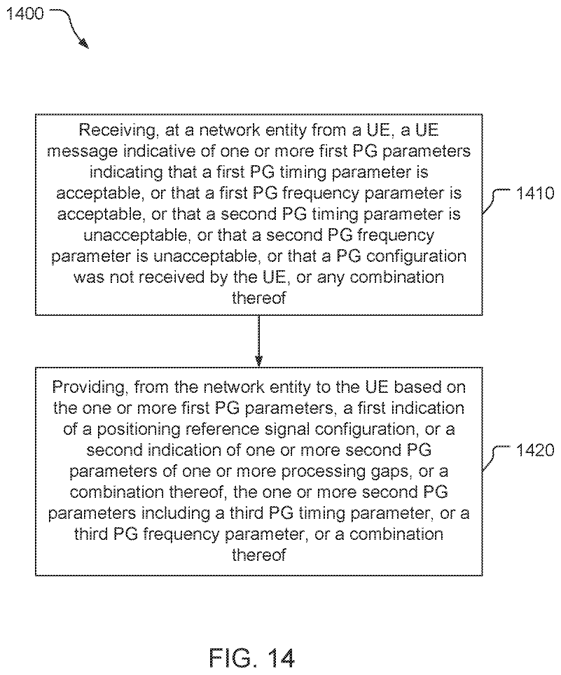

Referring to FIG. 14, with further reference to FIGS. 1-12, a positioning method 1400 (e.g., for assisting measurement of a positioning signal) includes the stages shown. The method 1400 is, however, an example and not limiting. The method 1400 may be altered, e.g., by having stages added, removed, rearranged, combined, performed concurrently, and/or having single stages split into multiple stages.

At stage 1410, the method 1400 includes receiving, at a network entity from a UE, a UE message indicative of one or more first PG parameters including indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof. For example, the server 400 receives the message 742 indicating that one or more proposed PG parameters (one or more PG timing parameters and/or one or more PG frequency parameters) is acceptable and/or that one or more proposed PG configuration parameters (one or more PG timing parameters and/or one or more PG frequency parameters) is unacceptable, or that the UE did not receive a PG configuration (e.g., within a threshold amount of time since requesting a PG configuration). The processor 410, possibly in combination with the memory 411, in combination with the transceiver 415 (e.g., the wireless receiver 444 and the antenna 446, or the wired receiver 454) may comprise means for receiving the UE message.

At stage 1420, the method 1400 includes providing, from the network entity to the UE based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof. For example, the server 400 may send the AD 752 to the UE 500. The AD 752 may provide a confirmation of a PRS schedule, or a reconfiguration of a PRS schedule. For example, the server 400 may confirm the PRS schedule if the UE message indicates that all proposed PG parameters of a PG configuration are acceptable, and provide a PRS reconfiguration in response to at least one PG parameter of each proposed PG configuration being indicated by the UE message as being unacceptable. The processor 410, possibly in combination with the memory 411, in combination with the transceiver 415 (e.g., the wireless transmitter 442 and the antenna 446, or the wired transmitter 452), may comprise means for providing the first indication or the second indication or a combination thereof.

Implementations of the method 1400 may include one or more of the following features. In an example implementation, the method 1400 comprises providing, in response to the UE message indicating that the second PG timing parameter is unacceptable, or indicating that the second PG timing parameter is unacceptable, or a combination thereof, the second indication of one or more second PG parameters including the third PG timing parameter with the third PG timing parameter being different from the second PG timing parameter, or the third PG frequency parameter with the third PG frequency parameter being different from the second PG frequency parameter, or a combination thereof. For example, the server 400 provides one or more new proposed PG configurations based on the UE message indicating that one or more previously-proposed PG configuration is(are) unacceptable to the UE 500, with the new proposed PG configuration(s) being different than the previously-proposed PG configuration(s) (each set of PG configuration parameter values of each new proposed PG configuration being different from any set of PG configuration parameter values of any the previously-proposed PG configuration(s)). In another example implementation, the method 1400 comprises providing the second indication of one or more second PG parameters indicating a plurality of processing gap configurations. For example, the server 400 can provide a PG configuration response, such as the PG configuration response 1100, with multiple proposed processing gap configurations. In a further example implementation, the method 1400 comprises: receiving a selection message, from the UE, indicating a selected one of the plurality of measurement configurations; and transmitting a processing gap configuration message, to a transmission/reception point, indicating the selected one of the plurality of measurement configurations. For example, the server 400 may receive the message 742 that includes a selection of one of a set of proposed processing gap configurations, and may send the AD 752 with a PRS schedule implicitly indicating the selected PG configuration and/or with an explicit indication (e.g., an acknowledgement of the selection) of the selected PG configuration. The processor 410, possibly in combination with the memory 411, in combination with the transceiver 415 (e.g., the wireless receiver 444 and the antenna 446, or the wired receiver 454) may comprise means for receiving the selection message. The processor 410, possibly in combination with the memory 411, in combination with the transceiver 415 (e.g., the wireless transmitter 442 and the antenna 446, or the wired transmitter 452), may comprise means for transmitting the processing gap configuration message.

### Implementation Examples

Implementation examples are provided in the following numbered clauses.

Clause 1. A UE comprising:
a transceiver;
a memory; and
a processor, communicatively coupled to the transceiver and the memory, configured to:
   transmit, via the transceiver to a network entity, a first PG message (processing gap message) including a first PG request for a first PG configuration; and
   transmit a second PG message via the transceiver to the network entity in response to lack of an acceptable response to the first PG message being received, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

Clause 2. The UE of clause 1, wherein the first PG request includes a plurality of first PG configurations, or the second PG message includes the second PG request which includes a plurality of second PG configurations that are different from the first PG request, or a combination thereof.

Clause 3. The UE of clause 2, wherein.
the first PG request includes the plurality of first PG configurations and indicates a first priority of the plurality of first PG configurations; or
the second PG message includes the second PG request which includes the plurality of second PG configurations that are different from the first PG request, and the second PG request indicates a second priority of the plurality of second PG configurations; or
a combination thereof.

Clause 4. The UE of clause 1, wherein the second PG message includes the PG error message and the PG error message indicates whether a proposed PG timing parameter is unacceptable, or whether a proposed PG frequency parameter is unacceptable, or a combination thereof.

Clause 5. The UE of clause 4, wherein the PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

Clause 6. The UE of clause 1, wherein the processor is configured to transmit the second PG message including the second PG request including the acceptance/rejection indication in response to the processor receiving the proposed PG configuration, the acceptance/rejection indication indicating whether the UE accepts the proposed PG configuration or rejects the proposed PG configuration.

Clause 7. The UE of clause 1, wherein the processor is configured to transmit the second PG message including the second PG request including the acceptance/rejection indication in response to the processor receiving a plurality of proposed PG configurations, the acceptance/rejection indication indicating a selected one of the plurality of proposed PG configurations that the UE accepts.

Clause 8. The UE of clause 1, wherein the processor is configured to transmit the second PG message including the second PG request in response to passage of a threshold amount of time since transmission of the first PG message without receipt of a PG configuration proposal.

Clause 9. The UE of clause 1, wherein the processor is configured to transmit the second PG message including the second PG request in response to passage of a threshold amount of time since transmission of the first PG message without receipt of a PG configuration proposal that is acceptable to the UE.

Clause 10. The UE of clause 9, wherein the first PG configuration includes a plurality of first PG configuration parameters, and wherein the processor is configured to determine whether the proposed PG configuration is acceptable to the UE based on whether the plurality of first PG configuration parameters meet at least one combination criterion.

Clause 11. A positioning method comprising:
transmitting, from a UE (user equipment) to a network entity, a first PG message (processing gap message) including a first PG request for a first PG configuration; and
transmitting a second PG message from the UE to the network entity in response to lack of an acceptable response to the first PG message being received by the UE, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

Clause 12. The method of clause 11, wherein the first PG request includes a plurality of first PG configurations, or the second PG message includes the second PG request which includes a plurality of second PG configurations that are different from the first PG request, or a combination thereof.

Clause 13. The method of clause 12, wherein:
the first PG request includes the plurality of first PG configurations and indicates a first priority of the plurality of first PG configurations; or
the second PG message includes the second PG request which includes the plurality of second PG configurations that are different from the first PG request, and the second PG request indicates a second priority of the plurality of second PG configurations; or
a combination thereof.

Clause 14. The method of clause 11, wherein the second PG message includes the PG error message and the PG error message indicates whether a proposed PG timing parameter is unacceptable, or whether a proposed PG frequency parameter is unacceptable, or a combination thereof.

Clause 15. The method of clause 14, wherein the PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

Clause 16. The method of clause 11, wherein the method comprises receiving the proposed PG configuration, wherein transmitting the second PG message comprises transmitting the second PG message including the second PG request including the acceptance/rejection indication in response to receiving the proposed PG configuration, the acceptance/rejection indication indicating whether the UE accepts the proposed PG configuration or rejects the proposed PG configuration.

Clause 17. The method of clause 11, wherein the method comprises receiving a plurality of proposed PG configurations, wherein transmitting the second PG message comprises transmitting the second PG message including the second PG request including the acceptance/rejection indication in response to receiving the plurality of proposed PG configurations, the acceptance/rejection indication indicating a selected one of the plurality of proposed PG configurations that the UE accepts.

Clause 18. The method of clause 11, wherein transmitting the second PG message comprises transmitting the second PG message including the second PG request in response to passage of a threshold amount of time since transmission of the first PG message without receipt of a PG configuration proposal.

Clause 19. The method of clause 11, wherein transmitting the second PG message comprises transmitting the second PG message including the second PG request in response to passage of a threshold amount of time since transmission of the first PG message without receipt of a PG configuration proposal that is acceptable to the UE.

Clause 20. The method of clause 19, wherein the first PG configuration includes a plurality of first PG configuration parameters, and wherein the method further comprises determining whether the proposed PG configuration is acceptable to the UE based on whether the plurality of first PG configuration parameters meet at least one combination criterion.

Clause 21. A UE (user equipment) comprising:
means for transmitting, to a network entity, a first PG message (processing gap message) including a first PG request for a first PG configuration; and
means for transmitting a second PG message from the UE to the network entity in response to lack of an acceptable response to the first PG message being received by the UE, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

Clause 22. The UE of clause 21, wherein the first PG request includes a plurality of first PG configurations, or the second PG message includes the second PG request which includes a plurality of second PG configurations that are different from the first PG request, or a combination thereof.

Clause 23. The UE of clause 22, wherein:
the first PG request includes the plurality of first PG configurations and indicates a first priority of the plurality of first PG configurations; or
the second PG message includes the second PG request which includes the plurality of second PG configurations that are different from the first PG request, and the second PG request indicates a second priority of the plurality of second PG configurations; or
a combination thereof.

Clause 24. The UE of clause 21, wherein the second PG message includes the PG error message and the PG error message indicates whether a proposed PG timing parameter is unacceptable, or whether a proposed PG frequency parameter is unacceptable, or a combination thereof.

Clause 25. The UE of clause 24, wherein the PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

Clause 26. The UE of clause 21, further comprising means for receiving the proposed PG configuration, wherein the means for transmitting the second PG message comprise means for transmitting the second PG message including the second PG request including the acceptance/rejection indication in response to receiving the proposed PG configuration, the acceptance/rejection indication indicating whether the UE accepts the proposed PG configuration or rejects the proposed PG configuration.

Clause 27. The UE of clause 21, further comprising means for receiving a plurality of proposed PG configurations, wherein the means for transmitting the second PG message comprise means for transmitting the second PG message including the second PG request including the acceptance/rejection indication in response to receiving the plurality of proposed PG configurations, the acceptance/rejection indication indicating a selected one of the plurality of proposed PG configurations that the UE accepts.

Clause 28. The UE of clause 21, wherein the means for transmitting the second PG message comprise means for transmitting the second PG message including the second PG request in response to passage of a threshold amount of time since transmission of the first PG message without receipt of a PG configuration proposal.

Clause 29. The UE of clause 21, wherein the means for transmitting the second PG message comprise means for transmitting the second PG message including the second PG request in response to passage of a threshold amount of time since transmission of the first PG message without receipt of a PG configuration proposal that is acceptable to the UE.

Clause 30. The UE of clause 29, wherein the first PG configuration includes a plurality of first PG configuration parameters, and wherein the UE further comprises means for determining whether the proposed PG configuration is acceptable to the UE based on whether the plurality of first PG configuration parameters meet at least one combination criterion.

Clause 31. A non-transitory, processor-readable storage medium comprising processor-readable instructions to cause a processor of a UE (user equipment) to:
transmit, to a network entity, a first PG message (processing gap message) including a first PG request for a first PG configuration; and
transmit a second PG message from the UE to the network entity in response to lack of an acceptable response to the first PG message being received by the UE, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

Clause 32. The non-transitory, processor-readable storage medium of clause 31, wherein the first PG request includes a plurality of first PG configurations, or the second PG message includes the second PG request which includes a plurality of second PG configurations that are different from the first PG request, or a combination thereof.

Clause 33. The non-transitory, processor-readable storage medium of clause 32, wherein:
the first PG request includes the plurality of first PG configurations and indicates a first priority of the plurality of first PG configurations; or
the second PG message includes the second PG request which includes the plurality of second PG configurations that are different from the first PG request, and the second PG request indicates a second priority of the plurality of second PG configurations; or
a combination thereof.

Clause 34. The non-transitory, processor-readable storage medium of clause 31, wherein the second PG message includes the PG error message and the PG error message indicates whether a proposed PG timing parameter is unacceptable, or whether a proposed PG frequency parameter is unacceptable, or a combination thereof.

Clause 35. The non-transitory, processor-readable storage medium of clause 34, wherein the PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

Clause 36. The non-transitory, processor-readable storage medium of clause 31, further comprising processor-readable instructions to cause the processor to receive the proposed PG configuration, wherein the processor-readable instructions to cause the processor to transmit the second PG message comprise processor-readable instructions to cause the processor to transmit the second PG message including the second PG request including the acceptance/rejection indication in response to receiving the proposed PG configuration, the acceptance/rejection indication indicating whether the UE accepts the proposed PG configuration or rejects the proposed PG configuration.

Clause 37. The non-transitory, processor-readable storage medium of clause 31, further comprising processor-readable instructions to cause the processor to receive a plurality of proposed PG configurations, wherein the processor-readable instructions to cause the processor to transmit the second PG message comprise processor-readable instructions to cause the processor to transmit the second PG message including the second PG request including the acceptance/rejection indication in response to receiving the plurality of proposed PG configurations, the acceptance/rejection indication indicating a selected one of the plurality of proposed PG configurations that the UE accepts.

Clause 38. The non-transitory, processor-readable storage medium of clause 31, wherein the processor-readable instructions to cause the processor to transmit the second PG message comprise processor-readable instructions to cause the processor to transmit the second PG message including the second PG request in response to passage of a threshold amount of time since transmission of the first PG message without receipt of a PG configuration proposal.

Clause 39. The non-transitory, processor-readable storage medium of clause 31, wherein the processor-readable instructions to cause the processor to transmit the second PG message comprise processor-readable instructions to cause the processor to transmit the second PG message including the second PG request in response to passage of a threshold amount of time since transmission of the first PG message without receipt of a PG configuration proposal that is acceptable to the UE.

Clause 40. The non-transitory, processor-readable storage medium of clause 39, wherein the first PG configuration includes a plurality of first PG configuration parameters, and wherein the non-transitory, processor-readable storage medium further comprises processor-readable instructions to cause the processor to determine whether the proposed PG configuration is acceptable to the UE based on whether the plurality of first PG configuration parameters meet at least one combination criterion.

Clause 41. A network entity comprising:
a transceiver;
a memory; and
a processor, communicatively coupled to the transceiver and the memory, configured to:
   receive, from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and
   provide, based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

Clause 42. The network entity of clause 41, wherein the processor is configured to provide, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof.

Clause 43. The network entity of clause 41, wherein the processor is configured to provide, via the transceiver to the UE, the second indication of the one or more second PG parameters indicating a plurality of processing gap configurations.

Clause 44. The network entity of clause 43, wherein the processor is configured to:
receive a selection message, from the UE via the transceiver, indicating a selected one of the plurality of processing gap configurations; and
transmit a processing gap configuration message, to a transmission/reception point, indicating the selected one of the plurality of processing gap configurations.

Clause 45. A positioning method comprising:
receiving, at a network entity from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and
providing, from the network entity to the UE based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

Clause 46. The method of clause 45, wherein the method comprises providing, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof.

Clause 47. The method of clause 45, wherein the method comprises providing the second indication of the one or more second PG parameters indicating a plurality of processing gap configurations.

Clause 48. The method of clause 47, wherein the method comprises:
receiving a selection message, from the UE, indicating a selected one of the plurality of processing gap configurations; and
transmitting a processing gap configuration message, to a transmission/reception point, indicating the selected one of the plurality of processing gap configurations.

Clause 49. A network entity comprising:
means for receiving, from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and
means for providing, to the UE based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

Clause 50. The network entity of clause 49, further comprising means for providing, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof.

Clause 51. The network entity of clause 49, further comprising means for providing the second indication of the one or more second PG parameters indicating a plurality of processing gap configurations.

Clause 52. The network entity of clause 51, further comprising:
means for receiving a selection message, from the UE, indicating a selected one of the plurality of processing gap configurations; and
means for transmitting a processing gap configuration message, to a transmission/reception point, indicating the selected one of the plurality of processing gap configurations.

Clause 53. A non-transitory, processor-readable storage medium comprising processor-readable instructions to cause a processor of a network entity to:
receive, from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and
provide, to the UE based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

Clause 54. The non-transitory, processor-readable storage medium of clause 53, further comprising processor-readable instructions to cause the processor to provide, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof.

Clause 55. The non-transitory, processor-readable storage medium of clause 53, further comprising processor-readable instructions to cause the processor to provide the second indication of the one or more second PG parameters indicating a plurality of processing gap configurations.

Clause 56. The non-transitory, processor-readable storage medium of clause 55, further comprising processor-readable instructions to cause the processor to:
receive a selection message, from the UE, indicating a selected one of the plurality of processing gap configurations; and
transmit a processing gap configuration message, to a transmission/reception point, indicating the selected one of the plurality of processing gap configurations.

Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, the term RS (reference signal) may refer to one or more reference signals and may apply, as appropriate, to any form of the term RS, e.g., PRS, SRS, CSI-RS, etc.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that communication using the wireless communication device is exclusively, or evenly primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or 10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A UE (user equipment) comprising:
a transceiver;
a memory; and
a processor, communicatively coupled to the transceiver and the memory, configured to:
transmit, via the transceiver to a network entity, a first PG message (processing gap message) including a first PG request for a first PG configuration; and
transmit a second PG message via the transceiver to the network entity in response to lack of an acceptable response to the first PG message being received, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

2. The UE of claim 1, wherein the first PG request includes a plurality of first PG configurations, or the second PG message includes the second PG request which includes a plurality of second PG configurations that are different from the first PG request, or a combination thereof.

3. The UE of claim 2, wherein:
the first PG request includes the plurality of first PG configurations and indicates a first priority of the plurality of first PG configurations; or
the second PG message includes the second PG request which includes the plurality of second PG configurations that are different from the first PG request, and the second PG request indicates a second priority of the plurality of second PG configurations; or
a combination thereof.

4. The UE of claim 1, wherein the second PG message includes the PG error message and the PG error message indicates whether a proposed PG timing parameter is unacceptable, or whether a proposed PG frequency parameter is unacceptable, or a combination thereof.

5. The UE of claim 4, wherein the PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

6. The UE of claim 1, wherein the processor is configured to transmit the second PG message including the second PG request including the acceptance/rejection indication in response to the processor receiving the proposed PG configuration, the acceptance/rejection indication indicating whether the UE accepts the proposed PG configuration or rejects the proposed PG configuration.

7. The UE of claim 1, wherein the processor is configured to transmit the second PG message including the second PG request including the acceptance/rejection indication in response to the processor receiving a plurality of proposed PG configurations, the acceptance/rejection indication indicating a selected one of the plurality of proposed PG configurations that the UE accepts.

8. The UE of claim 1, wherein the processor is configured to transmit the second PG message including the second PG request in response to passage of a threshold amount of time since transmission of the first PG message without receipt of a PG configuration proposal.

9. The UE of claim 1, wherein the processor is configured to transmit the second PG message including the second PG request in response to passage of a threshold amount of time since transmission of the first PG message without receipt of a PG configuration proposal that is acceptable to the UE.

10. The UE of claim 9, wherein the first PG configuration includes a plurality of first PG configuration parameters, and wherein the processor is configured to determine whether the proposed PG configuration is acceptable to the UE based on whether the plurality of first PG configuration parameters meet at least one combination criterion.

11. A positioning method comprising:
transmitting, from a UE (user equipment) to a network entity, a first PG message (processing gap message) including a first PG request for a first PG configuration; and
transmitting a second PG message from the UE to the network entity in response to lack of an acceptable response to the first PG message being received by the UE, the second PG message including a second PG request, or a PG error message, or a combination thereof, wherein the second PG request indicates a second PG configuration that is different from the first PG configuration, or an acceptance/rejection indication for a proposed PG configuration received by the UE, or a combination thereof, and wherein the PG error message indicates that no PG configuration message was received by the UE or that the proposed PG configuration was deficient.

12. The method of claim 11, wherein the first PG request includes a plurality of first PG configurations, or the second PG message includes the second PG request which includes a plurality of second PG configurations that are different from the first PG request, or a combination thereof.

13. The method of claim 12, wherein:
the first PG request includes the plurality of first PG configurations and indicates a first priority of the plurality of first PG configurations; or
the second PG message includes the second PG request which includes the plurality of second PG configurations that are different from the first PG request, and the second PG request indicates a second priority of the plurality of second PG configurations; or
a combination thereof.

14. The method of claim 11, wherein the second PG message includes the PG error message and the PG error message indicates whether a proposed PG timing parameter is unacceptable, or whether a proposed PG frequency parameter is unacceptable, or a combination thereof.

15. The method of claim 14, wherein the PG error message indicates that a proposed processing gap is too short, or that a proposed processing gap periodicity is incorrect, or that a proposed processing gap offset is incorrect, or that a proposed processing gap frequency range is incorrect, or that a proposed processing gap frequency band is incorrect, or that a proposed processing gap component carrier is incorrect, or any combination thereof.

16. The method of claim 11, wherein the method comprises receiving the proposed PG configuration, wherein transmitting the second PG message comprises transmitting the second PG message including the second PG request including the acceptance/rejection indication in response to receiving the proposed PG configuration, the acceptance/rejection indication indicating whether the UE accepts the proposed PG configuration or rejects the proposed PG configuration.

17. The method of claim 11, wherein the method comprises receiving a plurality of proposed PG configurations, wherein transmitting the second PG message comprises transmitting the second PG message including the second PG request including the acceptance/rejection indication in response to receiving the plurality of proposed PG configurations, the acceptance/rejection indication indicating a selected one of the plurality of proposed PG configurations that the UE accepts.

18. The method of claim 11, wherein transmitting the second PG message comprises transmitting the second PG message including the second PG request in response to passage of a threshold amount of time since transmission of the first PG message without receipt of a PG configuration proposal.

19. The method of claim 11, wherein transmitting the second PG message comprises transmitting the second PG message including the second PG request in response to passage of a threshold amount of time since transmission of the first PG message without receipt of a PG configuration proposal that is acceptable to the UE.

20. The method of claim 19, wherein the first PG configuration includes a plurality of first PG configuration parameters, and wherein the method further comprises determining whether the proposed PG configuration is acceptable to the UE based on whether the plurality of first PG configuration parameters meet at least one combination criterion.

21. A network entity comprising:
a transceiver;
a memory; and
a processor, communicatively coupled to the transceiver and the memory, configured to:
receive, from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and
provide, based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

22. The network entity of claim 21, wherein the processor is configured to provide, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof.

23. The network entity of claim 21, wherein the processor is configured to provide, via the transceiver to the UE, the second indication of the one or more second PG parameters indicating a plurality of processing gap configurations.

24. The network entity of claim 23, wherein the processor is configured to:
receive a selection message, from the UE via the transceiver, indicating a selected one of the plurality of processing gap configurations; and
transmit a processing gap configuration message, to a transmission/reception point, indicating the selected one of the plurality of processing gap configurations.

25. A positioning method comprising:
receiving, at a network entity from a UE (user equipment), a UE message indicative of one or more first PG parameters (processing gap parameters) indicating that a first PG timing parameter is acceptable, or that a first PG frequency parameter is acceptable, or that a second PG timing parameter is unacceptable, or that a second PG frequency parameter is unacceptable, or that a PG configuration was not received by the UE, or any combination thereof; and
providing, from the network entity to the UE based on the one or more first PG parameters, a first indication of a positioning reference signal configuration, or a second indication of one or more second PG parameters of one or more processing gaps, or a combination thereof, the one or more second PG parameters including a third PG timing parameter, or a third PG frequency parameter, or a combination thereof.

26. The method of claim 25, wherein the method comprises providing, in response to the UE message indicating that the second PG timing parameter is unacceptable, or indicating that the second PG timing parameter is unacceptable, or a combination thereof, the second indication of the one or more second PG parameters including the third PG timing parameter with the third PG timing parameter being different from the second PG timing parameter, or the third PG frequency parameter with the third PG frequency parameter being different from the second PG frequency parameter, or a combination thereof.

27. The method of claim 25, wherein the method comprises providing the second indication of the one or more second PG parameters indicating a plurality of processing gap configurations.

28. The method of claim 27, wherein the method comprises:
receiving a selection message, from the UE, indicating a selected one of the plurality of processing gap configurations; and
transmitting a processing gap configuration message, to a transmission/reception point, indicating the selected one of the plurality of processing gap configurations.
